(19) United States
(12) Patent Application Publication
(10) Pub. No.: US 2015/0169033 A1
(43) Pub. Date: Jun. 18, 2015

(54) SYSTEMS AND METHODS FOR POWER MANAGEMENT IN STACKABLE SWITCH

(71) Applicant: Cisco Technology, Inc., San Jose, CA (US)

(72) Inventors: Amitesh Shukla, San Jose, CA (US); Rajeev Malhotra, Fremont, CA (US)

(73) Assignee: Cisco Technology, Inc., San Jose, CA (US)

(21) Appl. No.: 14/105,240

(22) Filed: Dec. 13, 2013

(51) Int. Cl. G06F 1/32

(52) U.S. Cl. CPC G06F 1/3234

(57) ABSTRACT

A method for managing power consumption in a stackable switch system, the method comprises determining a power management strategy for a plurality of switches in a stackable switch system. The method also comprises determining, by a processor associated with a first switch of the stackable switch system, that at least one criterion for causing the second switch to enter a power save mode has been met, based on the determined power management strategy. The method further comprises providing a first command for causing a second switch of the stackable switch system to enter the power save mode. The method also comprises determining that at least one criterion for causing the second switch to exit the power save mode has been met, based on the determined power management strategy. The method further comprises providing a second command for causing the second switch to wake from the power save mode.

### TECHNICAL FIELD

The present disclosure relates generally to power management in network equipment and, more particularly, to systems and methods for efficiently managing power consumption in stackable switch equipment.

### BACKGROUND

As Internet usage continues to increase at an extremely rapid pace, the demand for network bandwidth capacity, particularly at peak usage time, also increases. Such demand for bandwidth capacity is exacerbated by the number of devices that use network resources as the primary means of communication. For example, several years ago, a typical employee workstation consisted of one networked device—a computer. It is not uncommon for each workstation to comprise several networked device, such as a computer, a VoIP phone, a networked printer, a smartphone, and a tablet device. The increasing use of Ethernet and IP technology as the primary communication medium for enterprise networks has significantly increased the need for network equipment that can be rapidly expanded to support the growing bandwidth needs of network users.

In order to provide network architects with the ability to design networks to meet current needs of its users while providing a cost-effective and flexible solution for expanding the network to meet demand required by future growth, network equipment manufacturers developed stackable network switch solutions. Stackable switches is a network switch configuration that comprises one or more standalone switches that are coupled together (or “stacked”), both physically and logically, to behave like a single, higher capacity switch. The capability to add or remove individual members from the stack allows the switch hardware to be flexibly scaled based on the discreet demands on the network. As such, costs associated with frequent upgrading or downgrading of hardware may be reduced or eliminated.

Although current stackable switch solutions allow network managers to quickly and easily add or remove individual switches to the stack based on the desired capacity of the switch, they may have significant drawbacks. First, because each individual switch in the stack is designed to operate as a standalone switch, it contains its own chassis and power supply. During operation, each switch in the stack consumes power as if was a standalone switch. As such, the ability to achieve power efficiency of the stack is generally limited to the capabilities of each individual switch to manage its own power consumption. With each switch operating under its own power management scheme, the ability to efficiently manage and track power consumption of the stackable switch as a whole may be severely limited.

Furthermore, because conventional stackable switches may be limited in their ability to manage power consumption for the switch stack as whole, the overall network management capabilities of the stack may suffer. For example, during off-peak times, one or more switch-members of the stack may enter a sleep or power-save mode due to lack of network traffic seen by the switch-member. Because it takes time to wake and warm-up from such a sleep mode, and because the wake process may not begin unless and until the switch-member receives a switch request due, for example, to an increase in network traffic at the start of a peak time, the switch stack may be delayed in becoming fully functional during peak times. Thus, in addition to the inefficient consumption of power during peak and off-peak times, the lack of a centralized power management solution for the switch stack may also limit the ability of the stack to effectively respond to rapid increases in demand for network capacity.

The presently disclosed systems and methods for holistic power management for stackable network switches are directed to overcoming one or more of the problems set forth above and/or other problems in the art.

### BRIEF DESCRIPTION OF THE DRAWINGS

FIG. 1 provides a diagram illustrating an exemplary network in which the presently disclosed systems and methods for power management in switch stack may be implemented, consistent with certain disclosed embodiments;

FIG. 2 provides a diagrammatic view of a exemplary switch stack and associated solution for programming the same, in accordance with certain disclosed embodiments;

FIG. 3 provides a schematic illustration of exemplary components of a switch element associated with a switch stack, consistent with certain disclosed embodiments;

FIG. 4 provides a flowchart illustrating an exemplary power management scheme performed by one or more switch-members of a switch stack, in accordance with certain disclosed embodiments; and

FIG. 5 provides a flowchart illustrating an exemplary network-traffic based power management scheme performed by one or more switch-members of a switch stack, consistent with certain disclosed embodiments.

### DETAILED DESCRIPTION

In accordance with one aspect, the present disclosure is directed to a method for managing power consumption in a stackable switch system. The method may comprise determining a power management strategy for a plurality of switches in a stackable switch system. The method may also comprise determining, by a processor associated with a first switch of the stackable switch system, that at least one criterion for causing the second switch to enter a power save mode has been met, based, at least in part, on the determined power management strategy. The method may further comprise providing, by the processor associated with the first switch, a first command for causing a second switch of the stackable switch system to enter the power save mode. The method may also comprise determining, by the processor associated with the first switch, that at least one criterion for causing the second switch to exit the power save mode has been met, based, at least in part, on the determined power management strategy. The method may further comprise providing, by the processor associated with the first switch, a second command for causing the second switch to wake from the power save mode.

According to another aspect, the present disclosure is directed to a power management system for a stackable switch system, comprising a switch stack control module associated with a first switch, the switch stack control module configured to maintain an active communication connection with a second switch when the second switch is in a power save mode. The stackable switch system may also include a processor, communicatively coupled to the switch stack control module. The processor may be configured to determine that at least one criterion for causing the second switch to enter a power save mode has been met. The processor may also be configured to provide, by the switch stack control module to the second switch, a first command for causing the second switch to enter the power save mode. The processor may be further configured to determine that at least one criterion for causing the second switch to exit the power save mode has been met. The processor may also be configured to provide, by the switch stack control module to the second switch, a second command for causing the second switch to wake from the power save mode.

In accordance with yet another aspect, the present disclosure is directed to a stackable switch system, comprising a first switch and a second switch. The second switch may comprise a processor disposed within the second switch, the processor communicatively coupled to the first switch and adapted to maintain an active communication connection with the first switch when the first switch is in a power save mode. The second switch may be configured to determine that at least one criterion for causing the first switch to enter a power save mode has been met and provide a first command for causing the first switch to enter the power save mode. The processor may also be configured to determine that at least one criterion for causing the first switch to exit the power save mode has been met and provide a second command for causing the first switch to wake from the power save mode.

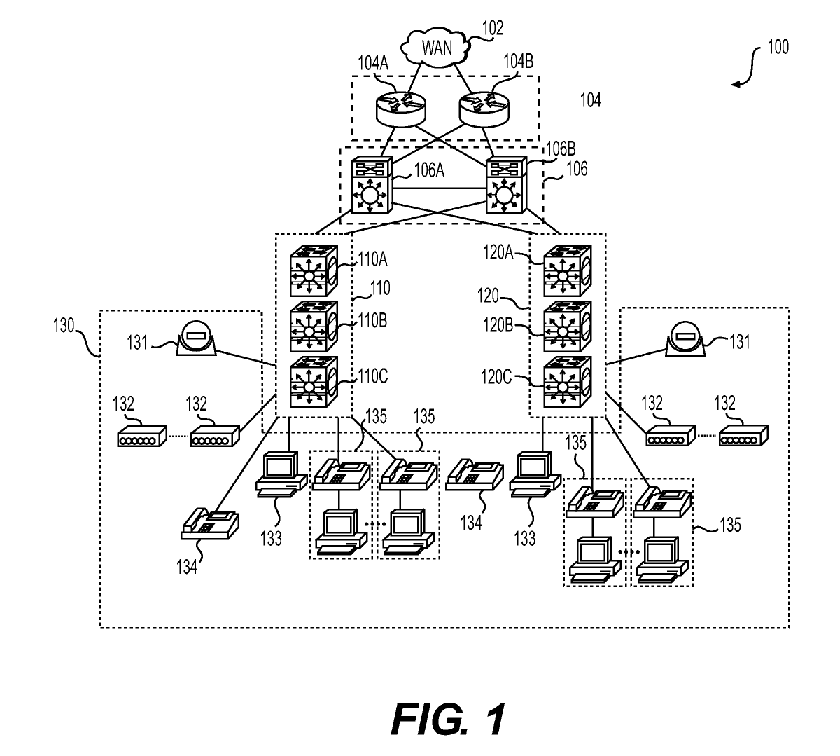

FIG. 1 provides a diagram illustrating an exemplary enterprise network 100 in which processes and systems consistent with the presently disclosed power management solutions may be implemented. Enterprise network 100 provides a platform on which a plurality of network-compatible devices 130 can share a common Ethernet and/or IP-based infrastructure for supporting data transfer for communications (e.g., email, VoIP, video-conferencing, etc.), file sharing, wired or wireless Internet access, audio or video streaming, and/or any other type of data transfer activity using any number of different networking protocols. According to one embodiment, and as illustrated in FIG. 1, network 100 may include one or more routers 104A, 104B coupled to a public communication wide area network (WAN) 102, such as the Internet. Each of routers 104A, 104B may be coupled to one or more multi-layer switches 106A, 106B and/or one or more stackable switch devices 110A, 120A. Stackable switch devices 110A, 110B provide a communication link for routing and delivering network data between and among network compatible devices 130. The number and type of components associated with network 100 are exemplary only and not intended to be limiting. Indeed, it is contemplated that network 100 may include additional, fewer, and/or different components than those illustrated in FIG. 1.

Communication network 102 may include or embody any data or telecommunications network that allows any number of network compatible devices 130 on enterprise network 100 to exchange data with other network compatible devices, both internal and external to enterprise network 100. For example, communication network 102 may communicatively couple network-compatible devices 130 with one or more servers on the World Wide Web using any combination wired or wireless communication platforms. Communication network 102 may include a wireless networking platform such as, for example, a satellite communication system, a cellular communication system, or any other platform for communicating data with one or more geographically dispersed assets (e.g., Bluetooth, microwave, point-to-point wireless, point-to-multipoint wireless, multipoint-to-multipoint wireless.) Alternatively or additionally, communication network 102 may include or embody wireline networks such as, for example, Ethernet, fiber optic, waveguide, or any other type of wired communication network.

Routers 104A, 104B may include any device suitable for directing data traffic between different networks, such as between enterprise network 100 can one or more other networks on communication network 102. According to one embodiment, routers 104A, 104B may embody any device suitable for supporting Layer 3 data communication between networks of communication network 102. Routers 104A, 104B may embody a gateway device that connects enterprise network 100 and other networks connected to communication network 102.

In certain embodiments, enterprise network 100 may include one or more multi-layer switches 106A, 106B. Multi-layer switches 106A, 106B may be any switch device suitable for performing Layer 2 and Layer 3 switching. In some situations (particularly in relatively small enterprise networks), multi-layer switches 106A, 106B may replace routers 104A, 104B. In other situations (particularly in the case of larger networks), multi-layer switches 106A, 106B may be used to communicate between different routers 104A, 104B and/or other switches, such as multi-layer switches 106A, 106B or switches 110, 120.

Network compatible devices 130 may include any of a variety of devices adapted to communicate data over enterprise network 102. For example, network compatible devices may be end-user devices such as computer workstations 133 (e.g., desktop computer, laptop computer, netbook computer, etc.) or IP telephony sets 134 that can be communicatively coupled to enterprise network 102 via wireline (e.g., Ethernet, fiber, etc.) or wireless (e.g., 802.11, Bluetooth, etc.) communication media. Alternatively or additionally, network compatible devices 130 may also include network resources, such as networkable storage media, printers, scanners, copiers, webcams 131, set-top boxes, streaming media devices, point-of-sale (POS) terminals, and any other types of input or output media that may be shared on enterprise network 100.

Network compatible devices 130 may also include one or more devices for facilitating connection with enterprise network 100. For example, network compatible devices 130 may include one or more wireless access points 132, for providing access to enterprise network 100 by wireless devices, such as smartphones, tablets, wearable media devices, or other wireless communication devices. Wireless access points 132 may be configured to communicate data using one or more wireless network protocols such as, for example, Wi-Fi (802.11*), Bluetooth, or any other suitable wireless access protocol.

Stackable switch devices 110, 120 may include or embody a network switch device in which a plurality of individual switches may be physically and logically linked to one another to form a single logical switch. According to one embodiment, stackable switch devices 110, 120 may include a plurality of individual switch members 110A-110C and 120A-120C, respectively. Each of the individual members 110A-110C, 120A-120C may be fixed-configured network switches that can operate in either a standalone mode or combined in a stack with other switches. When in a stacked configuration, one of the individual switch members is designated as a “master” or “active” switch controller and provides a common interface for administering the network of switches. Another of the individual switch members may be designated as a standby switch, in case the master/active switch becomes unavailable for some reason. According to one embodiment, stackable switch devices 110, 120 (and/or its individual members) may include or embody Cisco Catalyst 2960-X series switches.

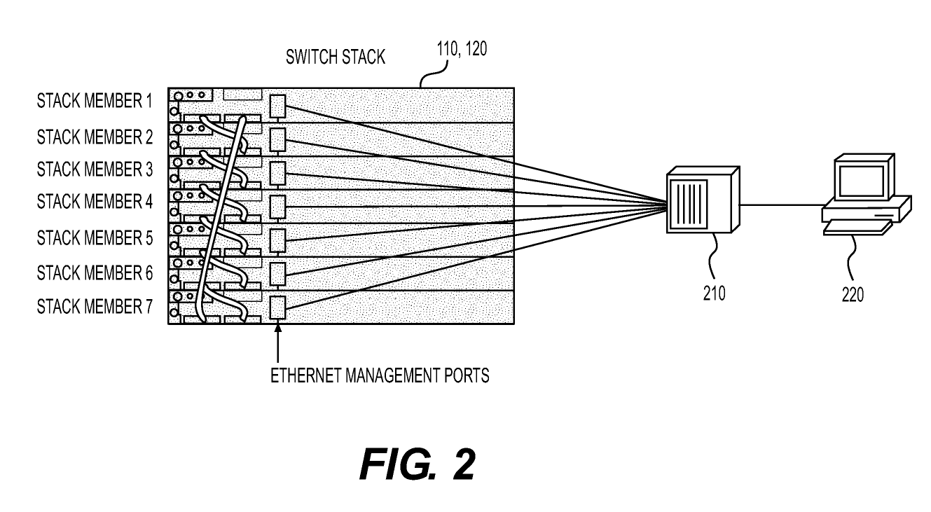

FIG. 2 illustrates an exemplary stackable switch 110, 120 comprising seven individual stack members. As illustrated in FIG. 2, the stack members are physically linked together in a ring topology, ensuring failover redundancy in case one of the members unexpectedly fails. One or more of the switches may be coupled to a management console computer 220 via a hub 210. Management console computer 220 may provide a user interface through which a network administrator can manage one or more of the switches in the stack. Although management console 220 is illustrated as being coupled to all of the switch members of stackable switch 110, 120, management console 220 may only require a connection with the master/active switch. One of the benefits of the stackable switch configuration is that the stack ring topology allows for management of all of the switches via a single, common interface.

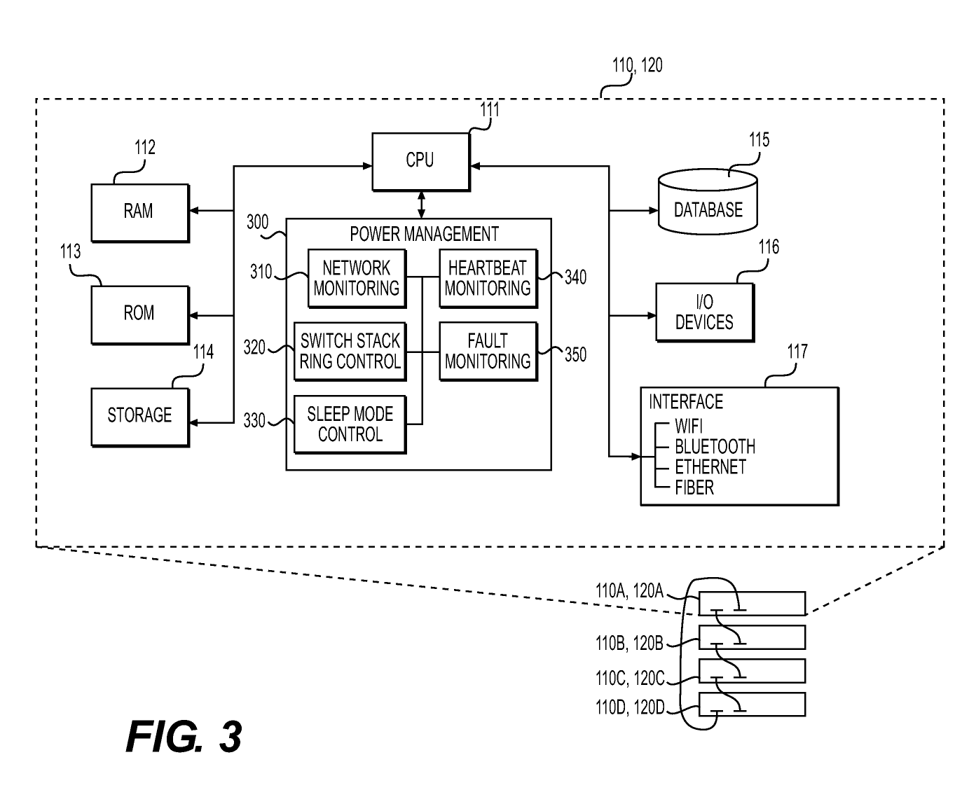

FIG. 3 illustrates a logical schematic diagram of certain exemplary components associated with switch member 110A, 120A. According to one exemplary embodiment, switch member 110A, 120A may be a processor-based network switching device that is configured to direct Layer 2 traffic between network compatible devices 130 associated with enterprise network 100, provide network management interface and support for stackable switch(es) 110, 120, coordinate ring control and switchover in case of a failure of one or more individual switch member, conduct fault monitoring and diagnostics, and manage power consumption for stackable switch(es) 110, 120 and its constituent members. Although the components illustrated and described with respect to a switch member 110A, 120A that is designated as the master switch for stackable switch devices 110, 120, respectively, it is contemplated that the other switch members 110B-110D, 120B-120D may include similar components as those shown in FIG. 3.

As illustrated in FIG. 3, switch member 110A, 120A may include one or more hardware and/or software components configured to execute software programs, such as software for performing network monitoring, switch stack control, power management, fault monitoring, and heartbeat detection. According to one embodiment, switch member 110A, 120A may include one or more hardware components such as, for example, a central processing unit (CPU) or microprocessor 111, a random access memory (RAM) module 112, a read-only memory (ROM) module 113, a memory or data storage module 114, a database 115, one or more input/output (I/O) devices 116, and an interface 117. Alternatively and/or additionally, switch member 110A, 120A may include one or more software media components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of switch member 110A, 120A. Switch member 110A, 120A may include additional, fewer, and/or different components than those listed above. It is understood that the components listed above are exemplary only and not intended to be limiting.

CPU 111 may include one or more processors, each configured to execute instructions and process data to perform one or more functions associated with switch member 110A, 120A. As illustrated in FIG. 3, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM 112 for execution by CPU 111.

RAM 112 and ROM 113 may each include one or more devices for storing information associated with an operation of switch member 110A, 120A and/or CPU 111. For example, ROM 113 may include a memory device configured to access and store information associated with switch member 110A, 120A, including information for identifying and registering MAC addresses associated with network compatible devices 130. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device. Alternatively or additionally, storage 114 may include flash memory mass media storage or other semiconductor-based storage medium.

Database 115 may include one or more software and/or hardware components that cooperate to store, organize, sort, filter, and/or arrange data used by switch member 110A, 120A and/or CPU 111. For example, database 115 may include a library of registered MAC addresses and their corresponding port locations. CPU 111 may access the information stored in database 115 to in order to identify the port locations associated with packets addressed to incoming MAC addresses. It is contemplated that database 355 may store additional and/or different information than that listed above.

I/O devices 116 may include one or more components configured to communicate information with a user associated with enterprise network 100. For example, I/O devices 116 may include a console with an integrated keyboard and mouse to allow a user to input parameters associated with switch member 110A, 120A. I/O devices 116 may also include a display including a graphical user interface (GUI) for providing a network management console for network administrators to configure stackable switch 110, 120. I/O devices 116 may also include peripheral devices such as, for example, a printer for printing information associated with switch member 110A, 120A, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via a communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via a communication network. According to one embodiment, interface 117 may be coupled to or include wireless communication devices, such as a module or modules configured to transmit information wirelessly using Wi-Fi or Bluetooth wireless protocols.

Power management capabilities of individual member switches 110A, 120A may be carried out by a customized power management control module 300. According to one embodiment, power management control module 300 may include a hardware module (such as an ASIC), a software module (such as a software process for executing by CPU 111), or a combination of hardware/software that operates to place and wake individual switches from a deep sleep mode in order to manage power consumption of the switch stack during non-peak periods. Because the master/active switch of stackable switch 110A, 120A is always kept in a fully operational (i.e., fully “awake” mode), it is uniquely situated to coordinate power management for the entire stack. According to certain embodiments, a minimum of one additional switch is designated as a standby switch in the stack. The standby switch is also kept in a fully operation mode, in substantially the same state as the master/active switch, in case of failure of the master/active switch.

According to one embodiment, power management module 300 may include a custom ASIC device that can be configured to operate in a plurality of different power modes, with each mode providing different communication capabilities for the switch. Alternatively or additionally, and in situations in which a stack member device does not include a multi-power mode ASIC device, power management module 300 may embody a plurality of software modules that, in cooperation with CPU and a wireless communication device, may function to provide the communication capabilities between the master/active switch and the other switches in stackable switch 110, 120. Power management module 300 may include a network monitoring module 310, a switch stack ring control module 320, a sleep mode control module 330, a heartbeat monitoring module 340, and a fault monitoring module 350. Although illustrated as separate logical units, it is contemplated that each of the components of power management module may include any combination of physical hardware components or logical software elements configured to perform the corresponding functionality of power management module 300.

Network monitoring module 310 may include hardware and/or software components that are configured to monitor the traffic associated with stackable switch 110, 120 and their constituent members. For example, network monitoring module 310 may include a software module that, when executed by CPU, is configured to monitor the network traffic associated with each of the individual switch members and the stackable switch as a whole. Network monitoring module 310 may be communicatively coupled to CPU 111 and may be configured to provide information indicative of the network traffic to CPU 111, which may, in turn, use this information to execute one or more power management schemes by power management module 300. According to one embodiment, CPU 111 may determine, based on network traffic information, that one or more of the members of stackable switch have little network traffic travelling across its ports. Based on this determination, CPU 111 may be configured to roll any capacity being handled by the low-traffic systems to an active switch, and place the low-traffic systems in a deep sleep (i.e., low power consumption) mode. Exemplary processes and methods for power management will be described in further detail below.

Switch stack ring control module 320 may provide the communication control plane across which each of the individual members of stackable switch 110, 120 may communicate. Specifically switch stack control module 320 allows the master/active switch to communicate with each of the other members in the switch stack. Switch stack control module 320 may provide an interface between the master/active switch and the other member switches to allow the master/active switch determine status information associated with each switch (i.e., whether it's in active mode, sleep mode, deep sleep mode, forwarding mode, etc.), provide explicit sleep and wake commands, query network traffic/load statistics, initiate diagnostic tests, and perform any of a number of other command, control, and diagnostic functions.

Sleep mode control module 330 may include hardware and/or software component(s) for issuing sleep mode commands between master/active switch and the other members of the switch stack. According to one embodiment, sleep mode control module 330 may be configured to generate sleep and wake commands based on certain programmable criteria. For example, sleep mode control module 330 may be configured to generate a sleep command causing a first group of switches in the stack to enter a deep sleep mode at a first predetermined time (e.g., 11 PM), and subsequently wake from the deep sleep mode at a second predetermined time (e.g., 6 AM).

Alternatively or additionally, sleep mode control module 330 may be configured to issue sleep and wake commands based on certain network traffic criteria. For example, sleep mode control module 330 may be configured to generate a deep sleep command for one or more switches when the network traffic/load information for the one or more switches falls below a first threshold level (indicating that the one or more switches are not sufficiently busy to justify keeping them awake). Before sending the command to the one or more switches, however, either sleep mode control module 330 or power management module 300 (or one of its constituent components) may determine that there is sufficient capacity on the active switches to effectively handle the network traffic from the one or more switches. Sleep mode control module 330 may be configured to generate a wake command for one or more sleeping switches, based on network traffic/load information for an active switch exceeding a second threshold level (indicating that the active switch is exceedingly busy).

It should be appreciated that sleep mode control module 330 is illustrated as being a separate module for the purposes of logical explanation. While it is certain possible that sleep mode control module 330 can be embodied by the specialize hardware circuit, such as a specialty ASIC device, it is also contemplated that it may include a software module whose functionality can be executed by a general purpose processor, such as CPU 111. As such, those skilled in the art will appreciate that the hardware and software functionality associated with sleep mode control module 330 may be combined with or integrated within one or more other hardware or software modules associated with power management module 300 or stackable switch device 110, 120.

Heartbeat monitoring module 340 may include any hardware or software component that allows the master/active switch to send periodic status (i.e., heartbeat) messages to the other members of stackable switch 110, 120 and receive acknowledgment messages in response to the status messages. In the event that heartbeat monitoring module fails to receive a responsive message to the status inquiry, heartbeat monitoring module 340 may be configured to perform remedial measures for diagnosing, resetting, or otherwise correcting the unresponsive switch. As with sleep mode control module 330, functionality associated with heartbeat monitoring module 340 may be combined with or integrated within one of the other hardware or software modules associated with power management module 300.

Fault monitoring module 350 may include or embody a hardware or software module configured to detect faults associated with one or more members of the switch stack. In the event of a catastrophic fault that disables the master/active switch, the standby switch may be configured to automatically intercede as the new master/active switch. In the case of a catastrophic fault on another member of the switch stack, fault monitoring module 350 may be configured to perform remedial measurement for diagnosing, resetting, or otherwise correcting the unresponsive switch.

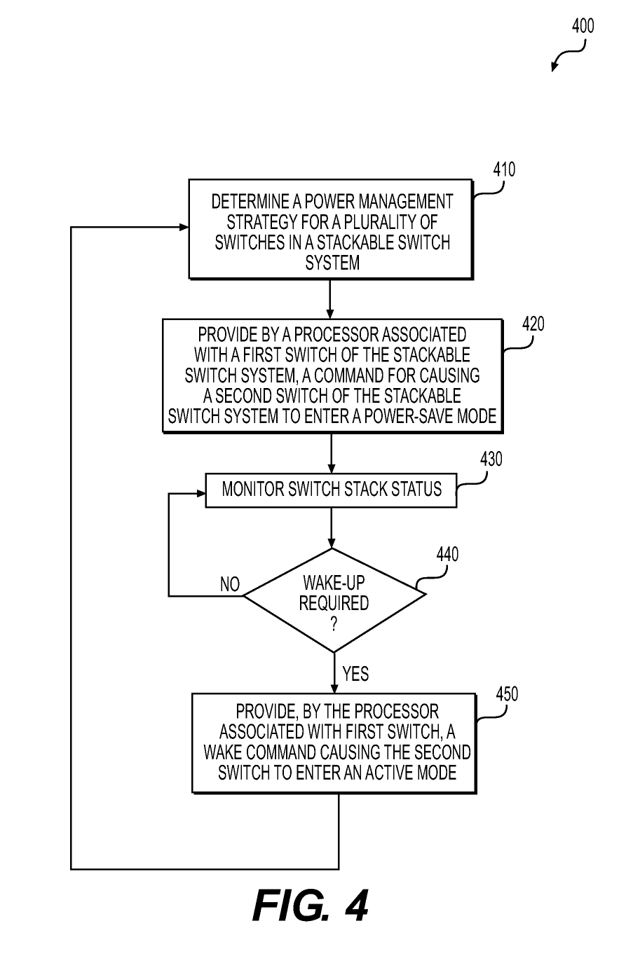

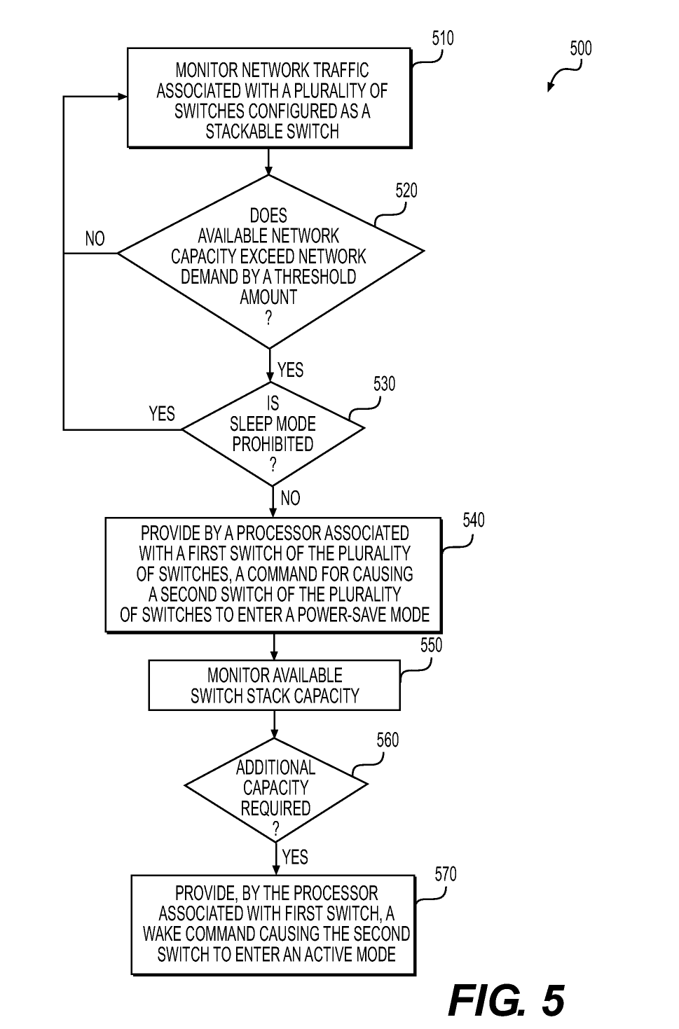

Processes and methods consistent with the disclosed embodiments provide a solution for managing power consumption in one or more stackable switches 110, 120. In particular, the presently disclosed features allow a single, master switch device to cause one or more other switch members to enter and wake from a deep sleep mode without losing switch stack ring communication capabilities. FIGS. 4 and 5 provide flowcharts illustrating exemplary power management processes which may be implemented in one or more of the stackable switch devices 110, 120, as described above.

FIG. 4 provides a flowchart 400 illustrating one exemplary power management process that can be implemented in a stackable switch device 110, 120. As illustrated in FIG. 4, the process may commence with a determination of a power management strategy for a plurality of switch in the stackable switch system (Step 410). According to one embodiment, a microprocessor associated with a master/active switch may determine the power management strategy based on a user-defined power management selection that is stored in memory. For example, a user (e.g., a network administrator) may configure the switch to operate a “schedule” mode, in which the master/active switch places one or more member switches in a deep sleep (or other reduced power consumption mode) based on a time schedule that is entered by the user and stored in memory of the master/active switch.

Alternatively or additionally, a user may configured the switch to operate according to a “demand” or network-traffic based approach, in which the master/active switch is configured to place member switches in a deep sleep or power save mode based on the amount of network traffic being handled by stackable switch 110, 120 as a whole. According to this strategy, the master/active switch may be configured to consolidate network switch traffic over as few switches as needed to handle the traffic, and place any under-utilized switches in a power save mode. The master/active switch may monitor the network traffic on the switch. Switches may be awoken from the power save mode as additional capacity is required.

Once the power management strategy has been determined by the processor associated with master/active switch, the master/active switch may be configured to cause one or more of the member switches to enter a power save mode, based on the power management strategy (Step 420). According to one embodiment, the master/active switch may be configured, for each member switch of the stack, to detect whether a criterion for causing the member switch to enter a power save (i.e., deep sleep) mode. In the “schedule” mode, the criterion for causing the switch to enter a power save mode is based on predetermined time schedule, where the sleep and wake times are established by a network administrator and stored in a database associated with the master/active switch. In the “demand” mode, the criterion for causing the switch to enter the power save mode is based on network traffic handled by the switch. If the network traffic handled by the switch falls below a predetermined level, the traffic may be rolled to another active switch so that the slow network-traffic switch can be placed in a power save mode.

Master/active switch may be configured to periodically or continuously monitor the status of the stackable switch and the individual members thereof (Step 430). As explained, the master/active switch may be configured to communicate with the other members of the stack via the stack ring control module associated with each of the switches in the stack. Importantly, each of the members of the stack is configured to communicate via the switch stack control module, even if the member of the switch stack is in a deep sleep or power-save mode.

In addition to monitoring the status of each of the members of the switch stack, the master/active switch may be configured to continually monitor the parameters associated with the switch with respect to the power management strategy. For example, in the schedule-based power management strategy, the master/active switch is configured to monitor the current time and compare the current time with the sleep and wake times contained in the schedule table. Similarly, in the demand-based power management strategy, the master/active switch may be configured to monitor the current network traffic and compare the network traffic with threshold levels required to add additional capacity (by waking one or more of switches in power-save mode).

Based on the status information, the master/active switch may be configured to determine whether any of the switches in power-save mode need to be awoken (Step 440). In the schedule-based power management strategy, for example, master/active switch may determine whether the current time associated with the stackable switch 110, 120 is equal to or later than a wake-up time established by the network administrator. If the comparison indicates that the wake-up criteria for one or more of the sleeping switches has been met, the master/active switch may provide a wake command to the corresponding switches (Step 450). If, on the other hand, the time criterion has not been met, the master/active switch may be configured to return to step 430 and monitor the status of the switch stack.

As explained, as an alternative or in addition to the schedule-based power management strategy, the stackable switch 110, 120 may be configured to execute a power management strategy based on the network traffic. FIG. 5 illustrates a flowchart 500 for a network-based power management process. According to one embodiment, the process involves monitoring network traffic associated with a plurality of switches configured as a stackable switch (Step 510). For example, network monitoring module 310 associated with power management module of the master/active switch may be configured to determine the network traffic that is being handled by each of the member switches associated with stackable switch 110, 120.

The network monitoring module 310 of the master/active switch may determine whether the available network capacity exceeds the network demand by a threshold amount (Step 520). According to one embodiment, the threshold level may be established by a network administrator, and may correspond to a value below which one or more other member switches may be placed in a power save mode in order to conserve power. If available network capacity does not exceed network demand, the network monitoring module 310 may return to step 510 and continue to monitor the network traffic. If, on the other hand, the network monitoring module 310 determines that the network capacity exceed network demand by the threshold amount, the network monitoring service sends a message to sleep mode control module 330.

Upon receipt of the message from network monitoring module 310, sleep mode control module 330 may determine whether a sleep or power save mode is prohibited (Step 530). There a couple of circumstances in which a power save mode may be prohibited by the sleep mode controller. For example, a power save mode may be prohibited during certain peak times associated with the enterprise network 100, regardless of whether the network traffic indications would otherwise allow commencement of a power save process. If the sleep mode is prohibited (Step 530: Yes), the process may return to step 510 to continue to monitor the network traffic.

If, on the other hand, sleep mode is not prohibited (Step 530: No), the process continues to provide a command for placing one or more of the member switch devices in a power save mode (Step 540). According to one embodiment, the sleep mode control module may generate a command signal for placing one or more of the switches in a power save mode. This command signal is passed to switch stack control module 320 which identifies, based on information collected by network monitoring module 310, one or more member switches to be placed in a power save (or deep sleep) mode. The command is then delivered to the one or more of members of the switch stack.

Network monitoring module 310 of the master/active device may be configured to monitor available switch capacity (Step 550) to determine whether additional network capacity is required (Step 560). If additional network capacity is required (Step 560: Yes), indicating that one or more of the switch members that were put in a power save mode may need to be awoken, sleep mode control module 330 of the master/active switch may generate a command for waking one or more of the switch members from the power save mode.

It will be apparent to those skilled in the art that various modifications and variations can be made to the disclosed systems and associated methods for power management in stackable switch devices. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for managing power consumption in a stackable switch system, the method comprising:
determining a power management strategy for a plurality of switches in a stackable switch system;
determining, by a processor associated with a first switch of the stackable switch system, that at least one criterion for causing the second switch to enter a power save mode has been met, based, at least in part, on the determined power management strategy;
providing, by the processor associated with the first switch, a first command for causing a second switch of the stackable switch system to enter the power save mode;
determining, by the processor associated with the first switch, that at least one criterion for causing the second switch to exit the power save mode has been met, based, at least in part, on the determined power management strategy; and
providing, by the processor associated with the first switch, a second command for causing the second switch to wake from the power save mode.

2. The method of claim 1, wherein determining the power management strategy includes:
receiving, by the processor associated with the first switch, information indicative of a schedule for placing the second switch in a power save mode;
storing, by the processor associated with the first switch, the received information indicative of the schedule in a table accessible by the processor; and
configuring, by the processor associated with the first switch, a sleep mode controller to cause the second switch to operate based, at least in part, on the schedule.

3. The method of claim 2, wherein determining that at least one criterion for causing the second switch to enter a power save mode has been met includes determining, by the processor based on the schedule, that a current time is substantially equal to or later than a scheduled time for placing the second switch in the power save mode.

4. The method of claim 2, wherein determining that at least one criterion for causing the second switch to exit the power save mode has been met includes determining, by the processor based on the schedule, that a current time is substantially equal to or later than a scheduled time for waking the second switch from the power save mode.

5. The method of claim 1, wherein determining the power management strategy includes:
receiving, by the processor associated with the first switch, information indicative of a network traffic threshold associated with the stackable switch system; and
configuring, by the processor associated with the first switch, a sleep mode controller to cause the second switch to operate based, at least in part, on network traffic associated with the stackable switch system.

6. The method of claim 5, wherein determining that at least one criterion for causing the second switch to enter a power save mode has been met includes determining, by the processor, that network traffic associated with the stackable switch system is equal to or less than the network traffic threshold.

7. The method of claim 5, wherein determining that at least one criterion for causing the second switch to exit the power save mode has been met includes determining, by the processor based on the schedule, that network traffic associated with the stackable switch system equal to or greater than the network traffic threshold.

8. The method of claim 1, wherein the providing of at least one of the first and second commands includes wirelessly transmitting the at least one of the first and second commands.

9. The method of claim 1, further comprising maintaining, by the processor associated with the first switch when the second switch is in a power save mode, an active stack ring communication channel with the second switch.

10. A power management system for a stackable switch system, comprising:
a switch stack control module associated with a first switch, the switch stack control module configured to maintain an active communication connection with a second switch when the second switch is in a power save mode;
a processor, communicatively coupled to the switch stack control module and configured to:
determine that at least one criterion for causing the second switch to enter a power save mode has been met;
provide, via the switch stack control module to the second switch, a first command for causing the second switch to enter the power save mode;
determine that at least one criterion for causing the second switch to exit the power save mode has been met; and
provide, via the switch stack control module to the second switch, a second command for causing the second switch to wake from the power save mode.

11. The power management system of claim 10, wherein the second switch includes an ASIC processor configured to operate in a plurality of power consumption modes including a power save mode, wherein the ASIC processor is configured to maintain active communication with the switch stack control module while the second switch is in a power save mode.

12. The power management system of claim 10, further comprising a wireless transceiver coupled to the switch stack control module and configured to maintain the active communication channel with the second switch via the wireless transceiver.

13. The power management system of claim 10, wherein the wireless transceiver includes a Bluetooth wireless communication device.

14. The power management system of claim 10, wherein determining that at least one criterion for causing the second switch to enter a power save mode has been met includes determining that a current time is substantially equal to or later than a scheduled time for placing the second switch in the power save mode.

15. The power management system of claim 10, wherein determining that at least one criterion for causing the second switch to exit the power save mode has been met includes determining that a current time is substantially equal to or later than a scheduled time for waking the second switch from the power save mode.

16. The power management system of claim 10, wherein determining that at least one criterion for causing the second switch to enter a power save mode has been met includes determining that network traffic associated with the stackable switch system is equal to or less than the network traffic threshold.

17. The power management system of claim 10, wherein determining that at least one criterion for causing the second switch to exit the power save mode has been met includes determining that network traffic associated with the stackable switch system equal to or greater than the network traffic threshold.

18. A stackable switch system, comprising:
a first switch;
a second switch comprising:
a processor disposed within the second switch, the processor communicatively coupled to the first switch and adapted to maintain an active communication connection with the first switch when the first switch is in a power save mode, the second switch configured to:
determine that at least one criterion for causing the first switch to enter a power save mode has been met;
provide a first command for causing the first switch to enter the power save mode;
determine that at least one criterion for causing the first switch to exit the power save mode has been met; and
provide a second command for causing the first switch to wake from the power save mode.

19. The stackable switch system of claim 18, wherein the first switch includes an ASIC processor configured to operate in a plurality of power consumption modes including the power save mode, wherein the ASIC processor is configured to communicate with second switch while the first switch is in the power save mode.

20. The stackable switch system of claim 18, wherein the first switch includes a first wireless transceiver and the second switch includes a second wireless transceiver, the second wireless transceiver coupled to processor and configured to establish a wireless communication channel with the first wireless transceiver, wherein the processor is configured to provide the first and second commands via the second wireless transceiver.

21. The stackable switch system of claim 18, wherein the first and second wireless transceivers each include a Bluetooth wireless communication device.

22. The stackable switch system of claim 18, wherein determining that at least one criterion for causing the first switch to enter a power save mode has been met includes determining that a current time is substantially equal to or later than a scheduled time for placing the first switch in the power save mode.

23. The stackable switch system of claim 18, wherein determining that at least one criterion for causing the first switch to exit the power save mode has been met includes determining that a current time is substantially equal to or later than a scheduled time for waking the first switch from the power save mode.

24. The stackable switch system of claim 18, wherein determining that at least one criterion for causing the first switch to enter a power save mode has been met includes determining that network traffic associated with the stackable switch system is equal to or less than the network traffic threshold.

25. The stackable switch system of claim 18, wherein determining that at least one criterion for causing the first switch to exit the power save mode has been met includes determining that network traffic associated with the stackable switch system equal to or greater than the network traffic threshold.
